(19) United States
(12) Patent Application Publication
(10) Pub. No.: US 2015/0200566 A1
(43) Pub. Date: Jul. 16, 2015

(54) REDUNDANT POWER SUPPLY SYSTEM FOR REDUCING STANDBY POWER CONSUMPTION

(71) Applicant: ZIPPY TECHNOLOGY CORP., New Taipei City (TW)

(72) Inventors: Yung-Hsin HUANG, New Taipei City (TW); Tsung-Chun CHEN, New Taipei City (TW)

(73) Assignee: ZIPPY TECHNOLOGY CORP., New Taipei City (TW)

(21) Appl. No.: 14/152,498

(22) Filed: Jan. 10, 2014

(51) Int. Cl. H02J 9/06; G08B 5/36

(52) U.S. Cl. CPC H02J 9/061; G08B 5/36

(57) ABSTRACT

A redundant power supply system for reducing standby power consumption includes a plurality of power supply modules and a power integration backboard. Each of the power supply modules includes an operating power modulation unit, a standby power modulation unit and a control unit connected to the standby power modulation unit. The power integration backboard is connected to the power supply modules, and includes an integration output unit and a standby power consumption management unit. The integration output unit integrates the operating powers and the standby powers of the power supply modules to provide an output to a load. The standby power consumption management unit outputs an operating signal to the control unit of each of the power supply modules according to a power consumption condition of the load, such that the control unit can activate or deactivate the standby power modulation unit according to the operating signal.

### FIELD OF THE INVENTION

The present invention relates to a redundant power supply system, and particularly to a redundant power supply system for reducing standby power consumption.

### BACKGROUND OF THE INVENTION

Advanced Technology Extended (ATX) is one of the most common, motherboard specifications. A power supply compliant to the ATX specification, instead of being directly connected to an activation switch of an information system, is only activated after being triggered by a motherboard. In normal conditions, the power supply constantly provides a standby power (commonly referred to as 5Vsb) to the motherboard that at all times allows the motherboard to readily enter an activated state. When the activation switch is pressed by a user, the motherboard outputs an activation signal to the power supply. The power supply then utilizes the standby power as an activation power for activating the output of operating power required for normal operations of the motherboard. The so-called operating power is, for example, 12V, 5V and 3.3V in the ATX specification.

In modern technologies, a redundant power supply system is proposed for meeting power supply stability requirements. In general, a redundant power supply system chiefly includes at least two power supply modules and a power integration backboard connected to the power supply modules. To provide power, the power integration backboard determines the power that each of the power supply modules outputs according to power consumption conditions of a load connected. That is to say, the power that the load consumes is provided in a shared manner by the power supply modules. If one of the power supply modules becomes damaged and malfunctions, the damaged power supply module is disengaged from the power integration backboard, and is replaced by another functional power supply module. However, each of the power supply modules utilized in the redundant power supply system may be individually regarded as a power supply. In addition to providing the motherboard with the required operating power, the power supply modules also convert and output the standing power. According to different power consumption requirements, the load needs both of the operating power in different amounts and the standby power. For example, the redundant power supply system includes four power supply modules, each of which constantly outputs 1 W of standby power. However, as the load requires only 1 W of the standby power, the remaining 3 W of the standby power is regarded as waste and is consumed by other components. That is to say, a current redundant power supply system is incapable of adjusting the amount of a standby power according to the amount of power that the load consumes, leading to unnecessary power waste.

### SUMMARY OF THE INVENTION

Therefore the primary object of the present invention is to provide a redundant power supply system capable of controlling an output standby power according to a power consumption condition of a load.

To achieve the above object, a redundant power supply system for reducing standby power consumption is provided. The redundant power supply system includes a plurality of power supply modules and a power integration backboard connected to the power supply modules. Each of the power supply modules is independently connected to an external power source to receive an external power. Each of the power supply modules includes an operating power modulation unit, a standby power modulation unit, and a control unit. The operating power modulation unit modulates the external power to output an operating power. The standby power modulation unit modulates the external power to output a standby power. The control unit, connected to the standby power modulation unit, is triggered by an operating signal to activate or deactivate the standby power modulation unit. The power integration backboard, connected to the power supply modules, includes an integration output unit and a standby power consumption management unit. The integration output unit is connected to the operating power modulation units and the standby power modulation units of the power supply modules to integrate the operating powers and the standby powers to provide an output to a load. The standby power consumption management unit outputs an operating signal to the control unit of each of the power supply modules according to a power consumption condition of the load, so as to enable the control unit to activate or deactivate the standby power modulation unit according to the operating signal.

In one embodiment, each of the power supply modules includes a housing, and a trigger switch disposed on the housing and connected to the control unit.

In one embodiment, each of the power supply modules includes a status indication lamp. The status indication lamp is connected to the control unit, and generates color variation according to a control status of the control unit controlling the standby power modulation unit.

In one embodiment, the operating power modulation unit of each of the power supply modules includes a rectification filter unit connected to the external power source, a power factor correction unit connected to the rectification filter unit, a transformer, a pulse width control unit, a switch element and a modulation output unit.

In one embodiment, the control unit of each of the power supply modules may be a semiconductor switch element.

With the above structure of the present invention, the present invention offers the following features compared to a conventional redundant power supply system. With the standby power consumption management unit of the present invention, a standby power corresponding to requirements of the load is outputted, thereby preventing power waste caused by a conventional redundant power supply system that is incapable of modulating the standby power.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram of components of a redundant power supply system for reducing standby power consumption according to an embodiment of the present invention; and

FIG. 2 is an appearance diagram of a redundant power supply system for reducing standby power consumption according to an embodiment of the present invention.

### DETAILED DESCRIPTION OF THE PREFERRED EMBODIMENTS

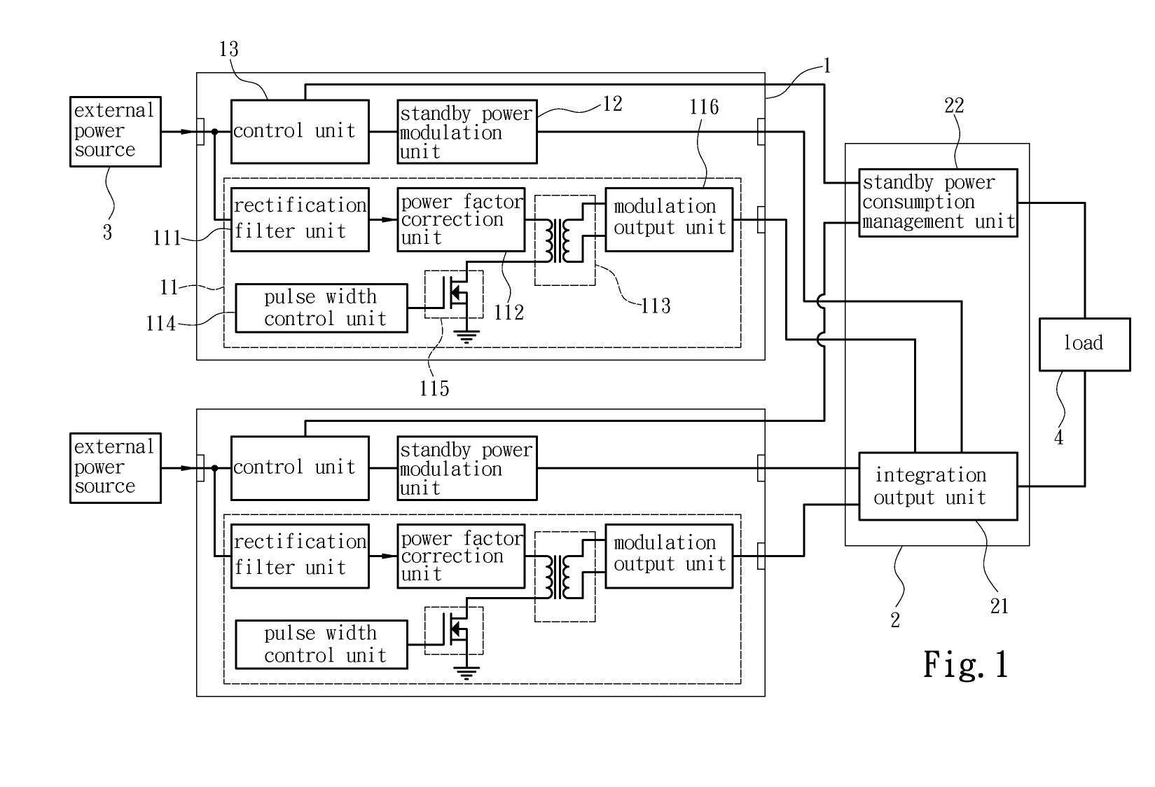

Referring to FIG. 1, a redundant power supply system for reducing standby power consumption according to an embodiment of the present invention mainly includes a plurality of power supply modules 1 and a power integration module 2. In the present invention, an example of two power supply modules 1 is given for illustration purpose, i.e., a redundant power supply system compliant to 1 U specification commonly referred to in the related field. In practice, the number of the power supply modules 1 of the redundant power supply system may be determined according to application requirements of the redundant power supply system. Each of the power supply modules 1 is independently connected to an external power source 3 to receive an external power. The external power source 3 may be a city power source or an industrial power source. Further, each of the power supply modules 1 includes an operating power modulation unit 11 and a standby power modulation unit 12. The operating power modulation unit 11 and the standby power modulation unit 12 are connected to the external power source 3 to receive the external power. The operation power modulation unit 11 modulates the external power to output an operating power, which is 12Vdc, 3.3Vdc or 5Vdc specified in the ATX motherboard specification, for example. The standby power modulation unit 12 modulates the external power to output a standby power, which is 5Vsb specified in the ATX motherboard specification, for example. Further, the operating power modulation unit 11 of each of the power supply modules 1 includes a rectification filter unit 111 connected to the external power source 3, a power factor correction unit 112 connected to the rectification filter unit 111, a transformer 113, a pulse width control unit 114, a switch element 115 and a modulation output unit 116. The rectification filter unit 111 of the operating power modulation unit 11 first rectifies and filters the external power, and the power factor unit 112 adjusts a power factor of the external power according to a transforming adjustment level. The pulse width control unit 114 outputs a driving signal for determining an operating cycle of the switch element 115. The switch element 115 periodically turns on and turns off to modulate a coil current of the transformer 113. The modulation output unit 116 modulates the power outputted by the transformer 113 to output the operating power. Similar to the above description, the standby power modulation unit 12 of the invention also modulates the external power. In practice, the standby power modulation unit 12 way be a buck power conversion module that steps down and converts the external power into the standby power. Each of the power supply modules 1 of the present invention further includes a control unit 13. The control unit 13, connected to the standby power modulation unit 12, may be disposed on a power supply path connecting the standby power modulation unit 12 and the external power source 3, and is triggered by an operating signal to control the activation or deactivation of the standby power modulation unit 12. In other words, in the present invention, the control unit 13 determines whether the standby power modulation unit 12 performs power conversion for outputting the standby power. When the control unit 13 deactivates the standby power modulation unit 12, the standby power modulation unit 12 stops outputting the standby power. When the control unit 13 activates the standby power modulation unit 12, the standby power modulation unit 12 receives the external power and modulates the external power to output the standby power. Further, the control unit 13 of the present invention may be a semiconductor switch element, e.g., a bipolar junction transistor (BIT), a metal oxide semiconductor field-effect transistor (MOSFET), or an insulated gate bipolar transistor (IGBT).

The power integration backboard 2 of the present invention, connected to the power supply modules 1, obtains power from the power supply modules 1 and provides the power to a load 4. For example, the load 4 may be an information apparatus such as a computer or a server. The power integration backboard 2 includes an integration output unit 21 and a standby power consumption management unit 22. The integration output unit 21 is connected to the operating power modulation units 11 and the standby power modulation units 12 of the power supply modules 1, and receives the operating powers and the standby powers from the operating power modulation units 11 and the standby power modulation units 12. After integrating the operating powers and the standby powers, the integration output unit 21 outputs the operating powers and the standby powers to the load 4. In practice, the integration output unit 21 may be a voltage regulator module disposed on the power integration backboard 2 in the related field. The standby power consumption management unit 22 is connected to the control units 13 of the power supply modules 1, and controls the control units 13. In the present invention, as the power integration backboard 2 provides the operating powers and the standby powers to the load 4, the standby power consumption management unit 22 obtains a power consumption condition of the load 4. That is to say, the standby power consumption management unit 22 constantly inspects the power consumption condition of the load. The standby power consumption management unit 22 further outputs the operating signal to the control unit 13 of each of the power supply modules 1 according to the power consumption condition of the load 4, so that the operating signal received by the control unit 13 controls the standby power modulation unit 12 to activate or deactivate. More specifically, assuming that the load 4 requires only 1 W of the standby power when the load 4 is under a standby state, the redundant power supply system constantly outputs 2 W of the standby power to the load 4 under a standby state when standby power consumption management is not performed. That is, each of the power supply modules 1 provides 1 W of the standby power to the load 4. In contrast, according to the power consumption condition of the load 4, the standby power consumption management unit 22 outputs the operating signal to the control unit 13 of each of the power supply modules 1, so that the standby power modulation unit 12 of one of the power supply modules 1 continues converting and outputting the standby power, while the other of the power supply modules 1 stops converting and outputting the standby power. As such, the power integration backboard 2 outputs only 1 W of the standby power, as needed by the load 4 under a standby state.

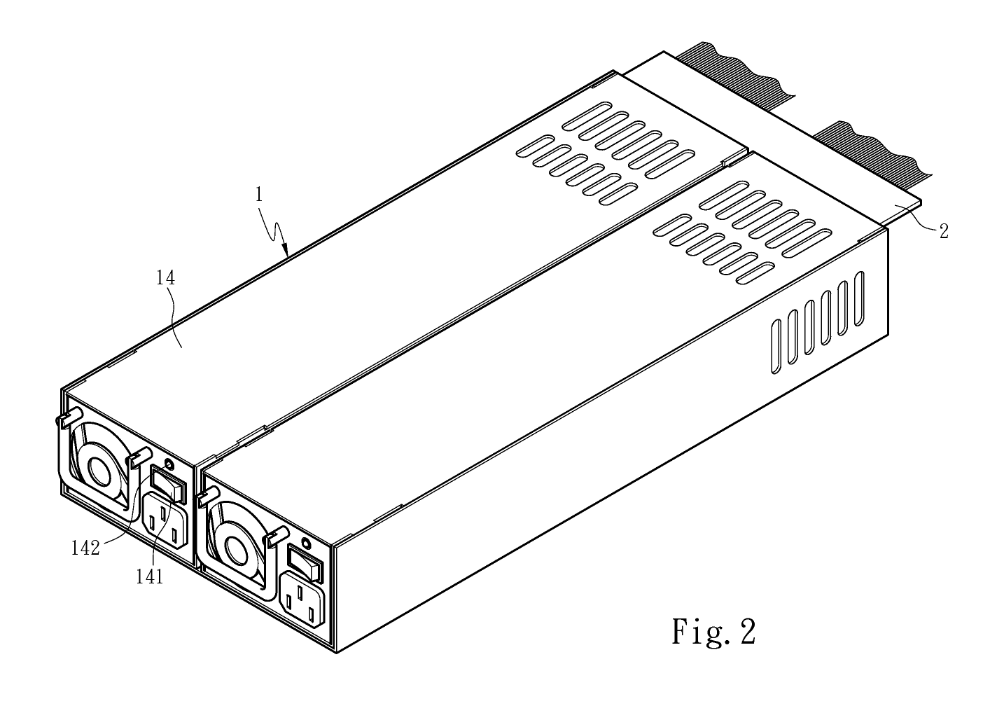

Referring to FIG. 2, according to an embodiment of the present invention, apart from controlling the standby power modulation unit 12 of each of the power supply modules 1 in the redundant power supply system by using the standby power consumption management unit 22, a trigger switch 141 that is connected to the control unit 13 may be further provided on a housing 14 of each of the power supply modules 1. A trigger condition of the trigger switch 141 determines whether to activate or deactivate the standby power modulation unit 12. Each of the power supply modules 1 may further include a status indication lamp 142. The status indication lamp 142 is connected to the control unit 13 of each of the power supply modules 1, and generates color variation according to a status of the control unit 13.

In conclusion, a redundant power supply system for reducing standby power consumption of the present invention includes a plurality of power supply modules and a power integration backboard. Each of the power supply modules includes an operating power modulation unit, a standby power modulation unit, and a control unit connected to the standby power modulation unit. The power integration backboard, connected to the power supply modules, includes an integration output unit and a standby power consumption management unit. The integration output unit integrates the operating powers and the standby powers of the power supply modules and provides an output to a load. The standby power consumption management unit outputs an operating signal to the control unit of each of the power supply modules according to the power consumption condition of the load, such that the control unit can accordingly activate or deactivate the standby power modulation unit, thereby effectively managing the standby power consumption of the redundant power supply system and thus enhancing power supply efficiency of the redundant power supply system.

What is claimed is:

1. A redundant power supply system for reducing standby power consumption, comprising:
a plurality of power supply modules, each of the power supply modules being independently connected to an external power source to receive an external power, each of the power supply modules comprising:
an operating power modulation unit for modulating the external power to output an operating power; and
a standby power modulation unit for modulating the external power to output a standby power; and
a control unit, connected to the standby power modulating unit, and triggered by an operating signal to activate or deactivate the standby power modulating unit; and
a power integration backboard, connected to the power supply modules, comprising:
an integration output unit, connected to the operating power modulation units and the standby power modulation units of the power supply modules for integrating the operating powers and the standby powers to provide an output to a load; and
a standby power consumption management unit for outputting the operating signal to the control unit of each of the power supply modules according to a power consumption condition of the load, such that the control unit activates or deactivates the standby power modulation unit according to the operating signal.

2. The redundant power supply system for reducing standby power consumption of claim 1, wherein each of the power supply modules comprises a housing and a trigger switch disposed on the housing and connected to the control unit.

3. The redundant power supply system for reducing standby power consumption of claim 1, wherein each of the power supply modules comprises a status indication lamp connected to the control unit for generating color variation according to a control status of the control unit controlling the standby power modulation unit.

4. The redundant power supply system for reducing standby power consumption of claim 2, wherein each of the power supply modules comprises a status indication lamp connected to the control unit for generating color variation according to a control status of the control unit controlling the standby power modulation unit.

5. The redundant power supply system for reducing standby power consumption of claim 1, wherein the operating power modulation unit of each of the power supply modules comprises a rectification filter unit connected to the external power source, a power factor correction unit connected to the rectification filter unit, a transformer, a pulse width control unit, a switch element and a modulation output unit.

6. The redundant power supply system for reducing standby power consumption of claim 1, wherein the control unit of each of the power supply modules is a semiconductor switch element.
